(19) United States
(12) Patent Application Publication
(10) Pub. No.: US 2011/0064959 A1
(43) Pub. Date: Mar. 17, 2011

(54) LOW-VOC LEATHER

(75) Inventors: Hirokazu Itoh, Yamagata-shi (JP); Keizo Kobayashi, Yamagata-shi (JP); Naoko Abe, Yamagata-shi (JP); Masahiko Sugimoto, Nikaho-shi (JP)

(73) Assignee: MIDORI HOKUYO CO., LTD., Yamagata-shi (JP)

(21) Appl. No.: 12/810,712

(22) PCT Filed: Dec. 26, 2008
(86) PCT No.: PCT/JP2008/004034

§ 371 Date: Jun. 25, 2010

(30) Foreign Application Priority Data
Dec. 28, 2007 (JP) 2007-341179

(51) Int. Cl. C14C 9/00; B32B 9/02

(52) U.S. Cl. 428/473; 252/8.57

(57) ABSTRACT

This object relates to a leather which is obtained by forming a coating film through the greasing step following re-tanning and dyeing and the drying step. The purpose of this object is to provide a leather, wherein the generation of free formaldehyde and acetaldehyde is inhibited, an automobile interior part using this leather and a back sizing agent for natural leather to be used for producing the above-described leather. A natural leather wherein a back sizing agent for natural leather containing a hydrazide compound optionally together with a resin (including an acrylic resin) is applied to the back of leather to exert an effect of fixing formaldehyde and acetaldehyde generated by a tanning agent, a re-tanning agent, a dye and a greasing agent, which have been incorporated into a leather, in the leather to thereby inhibit or prevent the generation of formaldehyde and acetaldehyde, an automobile interior part using this natural leather, and a back sizing agent for natural leather to be used for producing the above-described natural leather.

### TECHNICAL FIELD

The present invention relates to a leather associated with low generation volumes of VOCs (volatile organic compounds including formaldehyde and acetaldehyde) (hereinafter also referred to as “low-VOC leather”; the terms “skin leather”, “leather”, and “natural leather” are hereinafter used synonymously).

### Prior Art

Seats, steering wheels, shift knobs, instrument panels and other automobile interior parts use natural leathers. The process of manufacturing a natural leather from an animal hide such as cowhide comprises a step before tanning, a tanning step where a tanning agent is used, a re-tanning step where again a tanning agent is used, a dyeing step where a dye is used, a greasing step where a greasing agent is used, a drying step, and coating film-forming step. When implementing this series of steps, it is possible to complete the tanning step and successively perform the re-tanning and subsequent steps, or move to a different location to perform the re-tanning and subsequent steps there.

As for tanning agents, chromium compounds have traditionally been used. However, manufacturers are now switching to methods using tanning agents free from chromium compounds, such as vegetable tanning agents, synthetic tanning agents and glutaraldehyde.

As for dyes, various dyes are used including acid dyes having a sulfonic acid group or carboxylic acid group, direct dyes having the sulfonic acid group, basic dyes having a nitrogen base, reactive dyes, and sulfur dyes.

As for greasing agents, anionic greasing agents, cationic greasing agents, amphoteric greasing agents, nonionic greasing agents and fatty acid soaps are used, among others.

After the greasing step and subsequent drying step, a coating material is applied onto the leather to form a coating film. Polyurethane resin and other synthetic resins are used in the forming of coating film.

Natural leathers manufactured by the aforementioned process and then coated with a coating film comprising a coating material and formed on the leather surface are used as materials for automobile interior parts such as steering wheels, shift knobs, instrument panels and seats, where leathers having unique characteristics such as wear resistance and favorable touch can be obtained. Whatever the case, automobile interior parts using leathers have been developed under strict control conditions. When the leathers used in automobile interior parts thus developed were measured, however, formaldehyde, acetaldehyde and other VOCs (volatile organic compounds) were detected, indicating that these leathers were sources of VOCs present in air in the cabin of these automobiles.

The Japan Automobile Manufacturers Association is working to make sure VOC concentrations in automobile cabins meet the guideline values set by the Ministry of Health, Labour and Welfare, and accordingly automakers and leather manufacturers are doing their best to bring VOC concentrations in automobile cabins to compliance with the guideline values.

Reasons why the aforementioned VOCs generate or specific mechanisms of their generation are not yet understood fully. Based on this premise, there are calls for methods to minimize the amounts of formaldehyde, acetaldehyde, etc., in automobile cabins to the target values or below. To be specific, it is necessary to list and examine all possible means to achieve the above.

Leather materials manufactured from animal hides are used as materials for automobile interior parts. Automobile cabins are known to be exposed to extremely high temperatures, much higher than the temperatures in normal living space. When this occurs, volatile components in materials volatilize at these high temperatures, attach to the glass surface where they are cooled and condense again, and these deposits of re-condensates cause the window glass to fog. The fogged glass obstructs the driver's view and reduces driving safety. This phenomenon is called “fogging.” Fogging occurs due to volatilization of volatile components at high temperatures (100 to 120° C.), and is different from the problem currently presenting concerns which is caused by formaldehyde, acetaldehyde and other substances present in the cabin environment even when the environment is not heated at all.

Methods to reduce the generation of formaldehyde, acetaldehyde, etc., in automobile cabins include those listed below.

Because tanning agents used in the tanning step are cited as a cause of formaldehyde generation, tanning agents that do not generate formaldehyde, such as those using hydroxyalkylphosphine compounds, are being developed (Patent Literature 1, Published Japanese Translation of PCT International Patent Application No. Hei 6-502886; Patent Literature 2, Japanese Patent Laid-open No. 2005-272725; and Patent Literature 3, Japanese Patent Laid-open No. 2006-8723). Currently, obtaining synthetic tanning agents from phenolsulfonic acid and formaldehyde is considered one of the most appropriate approaches (Patent Literature 4, Japanese Patent Laid-open No. 2000-119700).

However, currently tanning and re-tanning using these newly developed tanning agents mentioned above is not yet considered as effective as the results achieved by conventional tanning and re-tanning treatments, and therefore this approach cannot possibly provide a sufficient solution. Also, this approach does not touch on prevention of another problem currently debated, or specifically generation of residual acetaldehyde, along with formaldehyde, from leathers, and in this sense this approach is not expected to offer a fundamental solution at the present.

In addition to the methods mentioned above, other methods are known, such as one that comprises the first step where the target leather is tanned without using formalin, and the second step where the aforementioned leather completing the aforementioned first step is tanned with oil in a rotary drum and the temperature in the aforementioned rotary drum is gradually raised to oxidize the leather in the aforementioned rotary drum (Patent Literature 5, Japanese Patent Laid-open No. 2005-272725). The aforementioned means does not examine treating formaldehyde and acetaldehyde in the steps constituting the latter half of the leather manufacturing process, and consequently it cannot offer a solution.

Currently reasons why the aforementioned VOCs generate or specific mechanisms of their generation are not yet understood fully, and even if we want to minimize the amounts of formaldehyde, acetaldehyde, etc., in automobile cabins to the target values or below, there are no clear means to specifically achieve the above and therefore the market is waiting for an effective solution to be developed as soon as possible.

Methods to remove formaldehyde and acetaldehyde, which are used in areas other than manufacturing of natural leathers, include the following:
(1) In manufacturing processes where the chemical reaction produces formaldehyde or acetaldehyde byproducts, methods to inhibit generation amounts to certain levels or return the finally isolated formaldehyde and acetaldehyde back to the reaction system and thereby keep generation amounts constant at all times are used more often than methods to remove all formaldehyde or acetaldehyde byproducts from the system and thereby eliminate formaldehyde and acetaldehyde in the final product.
   (i) Methods to remove formaldehyde and acetaldehyde byproducts generated in propyleneoxide include recycling formaldehyde and acetaldehyde byproducts and putting recycled byproducts back into the system, and in some cases formaldehyde and acetaldehyde are removed from the system together with water (Patent Literature 6, Japanese Patent Laid-open No. 2007-84527).
   (ii) In the manufacture of ethylene vinyl acetate emulsion, an inorganic reducing agent is added to the reaction system beforehand to prevent generation of acetaldehyde and other aldehydes (Patent Literature 6, Japanese Patent Laid-open No. 2003-277411).
      Under the above inventions, however, the reaction targeting formaldehyde and acetaldehyde byproducts generated in the system continues. Furthermore, there is no mention of any method that can be used to prevent generated formaldehyde and acetaldehyde from leaking out of the treated leather.
(2) If formaldehyde or acetaldehyde confined in a molded product or generated from a molded product by means of breakdown in a molded product scatters into air, an additive that traps formaldehyde and acetaldehyde in the product is added in an initial stage of manufacturing the product in order to prevent formaldehyde and acetaldehyde from generating as a result of breakdown, etc. To be specific, in the stage of manufacturing a molding from a plastic molding material used for automobile interior parts, such as polyurethane foam molding, resin powder for slash molding or polyacetal resin composition molding, either carbohydrazide or acetic acid hydrazide, or adipic acid dihydrazide, aromatic carboxylic acid hydrazide, adipic acid dihydrazide, 1,2,3,4-butane tetra carboxylic acid hydrazide, etc., may be added to all areas of the product, including the interior and exterior, to prevent formaldehyde and acetaldehyde from leaking out of the leather (Cited Literature 7, Japanese Patent Laid-open No. 2006-182825; Patent Literature 8, Japanese Patent Laid-open No. 2006-188669; Patent Literature 9, Japanese Patent Laid-open No. 2006-321880; Patent Literature 10, Japanese Patent Laid-open No. 2006-321929; Patent Literature 11, Japanese Patent Laid-open No. 2005-325225; and Patent Literature 12, Japanese Patent Laid-open No. 6-080619).

One method to deal with the scattering into air of formaldehyde and acetaldehyde confined in a high-molecular compound or generating from a high-molecular compound by means of breakdown is to add beforehand an additive that traps formaldehyde and acetaldehyde to all areas of the high-molecular compound including the interior as well as corners and edges. However, this method can be applied only to moldings obtained from high-molecular compounds.

It is not expected that formaldehyde and acetaldehyde can be trapped in the natural leather by coating a formaldehyde/acetaldehyde trapping agent on the exterior of the natural leather that already contains treatment agents used in the step of treating the leather with a tanning agent, re-tanning step of the leather, dyeing step and greasing step.
(3) If presence of formaldehyde, etc., in air is undesirable, a substance capable of adsorbing formaldehyde can be used to fix formaldehyde, so that it becomes no longer present in air. Examples of this method include the following:
   (i) Coat a hydrazide compound onto silica gel or alumina grains to purify air (Patent Literature 13, Japanese Patent Laid-open No. 2007-167495).
   (ii) Efficiently remove odorous components such as formaldehyde and acetaldehyde dispersed in the air, and eliminate the odors of at least formaldehyde and other aldehydes in the air, by providing the carpet or fiber material with an adsorbent that adsorbs aldehydes (=fixing adipic acid dihydrazide in gel form) (Patent Literature 14, Japanese Patent Laid-open No. Hei 11-46965).
   (iii) Provide an anti-slip part made of foam rubber on the surface of at least one side of the seat, wherein an adipic acid dihydrazide compound is present in such anti-slip part as an adsorbent that adsorbs aldehydes (Patent Literature 15, Japanese Patent No. 3053373 Specification).
   (iv) Provide an adhesive layer on the back side of the base material containing, impregnated with, or coated with, a formaldehyde trapping agent (Patent Literature 16, Japanese Patent Laid-open No. Hei 10-102782). This method applies only to formaldehyde.
   (v) Provide a deodorizing fiber effective on aldehydes and phenols by fixing onto the fiber surface a hydrazide compound containing at least two hydrazine groups in the molecule and forming a cross-link with a multifunctional monomer, and then by attaching 0.1 to 10 percent by weight of this hydrazide compound, such as adipic acid dihydrazide compound, relative to the fiber (Patent Literature 17, Japanese Patent Laid-open No. Hei 9-78452).
      This method aims to adsorb and remove formaldehyde suspended in air and does not provide or indicate any means or method aimed at confining formaldehyde and acetaldehyde within a leather where they generate.
   (vi) With respect to formaldehyde confined in leather, a method to remove formaldehyde after it has eluted into water was examined, wherein specifically treating such formaldehyde using sodium hydrogen sulfite, urea and ammonium water was examined. Also, hide powder was treated with a chromium tanning agent, after which the treated hide powder was fed through an aldehyde chromium exhaustion promotion process and then washed with water to measure the change in formaldehyde concentration. In addition, pig skin tanned with formaldehyde (FA leather) was treated with a sodium hydrogen sulfite solution and ammonium water to measure the amount of formaldehyde that eluted. Furthermore, chamois skin was treated with a sodium hydrogen sulfite solution, bisulfite ammonium solution, urea solution and ammonium water to calculate the removal ratio of formaldehyde. Finally, leather treated with a chromium tanning agent, anionic resin tanning agent and cationic resin tanning agent was measured for the amount of formaldehyde that eluted (Hikaku Kagaku (Leather Chemistry) Vol. 34, No. 4, p. 177). The foregoing is aimed at removing eluted formaldehyde using an aqueous sodium hydrogen sulfite solution, etc., and does not mention prevention of formaldehyde generation by means of trapping and thereby fixing formaldehyde within the leather.
      Instead of trapping the target formaldehyde which is present in the applicable substance, the aim of the foregoing means is to abandon trapping this formaldehyde within the substance, but to actively remove it to the outside using an aqueous solution and then trap the removed formaldehyde. What is described here is a treatment used in analytical chemistry, etc., and it does not provide a method to defend against generation of formaldehyde.
      Treatments using urea, sodium disulfide, etc., are also described, but fixing of formaldehyde in the leather in these applications is not mentioned.
   (vii) The applicants of the present patent earlier found a countermeasure to prevent fogging by revealing that fogging of glass is caused by lipid derived from cowhide and lipid derived from a chemical agent (greasing agent) used in the manufacturing process, where some of these lipids volatilize at high temperatures and then attach to the glass surface where they cool and condense again to eventually cause fogging of the glass. To be specific, the applicants developed an invention to “prevent heat shrinkage while reducing volatile substances to inhibit fogging, and also inhibit generation of foul smell due to oxidization, even in areas subject to a severe use environment, by (1) using a softening agent to avoid use of any greasing agent that causes fogging and foul smell, (2) using a synthetic tannin to avoid use of any vegetable tannin that causes fogging and foul smell, (3) using an anti-oxidant to inhibit generation of volatile substances and foul smell due to acid decomposition of lipids, etc., (4) inducing shrinking beforehand by means of heat treatment, and (5) applying resin on the back side to cut off release of volatile substances (Patent Literature 18, Japanese Patent Laid-open No. 2007-070487). However, this is a countermeasure to substances generated from leathers at high temperatures and causing fogging, and does not describe a method to defend against generation of formaldehyde and acetaldehyde at normal temperature.
Patent Literature 1: Published Japanese Translation of PCT International Patent Application No. Hei 6-502886
Patent Literature 2: Japanese Patent Laid-open No. 2005-272725
Patent Literature 3: Japanese Patent Laid-open No. 2006-8723
Patent Literature 4: Japanese Patent Laid-open No. 2000-119700
Patent Literature 5: Japanese Patent Laid-open No. 2005-272725
Patent Literature 6: Japanese Patent Laid-open No. 2007-84527
Patent Literature 7: Japanese Patent Laid-open No. 2003-277411
Patent Literature 8: Japanese Patent Laid-open No. 2006-182825
Patent Literature 9: Japanese Patent Laid-open No. 2006-188669
Patent Literature 10: Japanese Patent Laid-open No. 2006-321880
Patent Literature 11: Japanese Patent Laid-open No. 2006-321929
Patent Literature 12: Japanese Patent Laid-open No. 2005-325225
Patent Literature 13: Japanese Patent Laid-open No. 6-080619
Patent Literature 14: Japanese Patent Laid-open No. 2007-167495
Patent Literature 15: Japanese Patent Laid-open No. Hei 11-46965
Patent Literature 16: Japanese Patent No. 3053373
Patent Literature 17: Japanese Patent Laid-open No. Hei 10-102782
Patent Literature 18: Japanese Patent Laid-open No. Hei 9-78452
Patent Literature 19: Japanese Patent Laid-open No. 2007-070487
Non-patent Literature 1: Hikaku Kagaku (Leather Chemistry) Vol. 34, No. 4, p. 177

### SUMMARY OF THE INVENTION

### Problems to Be Solved by the Invention

The object of the present invention is to provide, in relating to a natural leather obtained through tanning, re-tanning, dyeing, greasing and drying steps, and by forming a coating film on it after the aforementioned processes: a natural leather that inhibits or prevents separation and release from the natural leather of formaldehyde and acetaldehyde that break free as a result of breakdown of an internal substance of the natural leather or any substance taken into the leather, wherein such natural leather also has fibers at the back of the leather fixed in place; as well as an agent to be applied or coated onto the back of the natural leather in order to inhibit or prevent generation from the natural leather of formaldehyde and acetaldehyde confined in the natural leather and also to fix in place the fibers at the back of the natural leather (this agent is hereinafter also referred to simply as “back sizing agent”).

### Means for Solving the Problems

After working on the aforementioned object in earnest, the inventors of the present invention revealed the following and consequently completed the present invention:
(1) After treating the leather through the tanning step where a tanning agent is used, re-tanning step where a synthetic tanning agent, etc., is used, dyeing step where a dye is used, and greasing step where a greasing agent is used, a back sizing agent containing a hydrazide compound or a hydrazide compound and synthetic resin (an agent applied or coated to the back of the natural leather to prevent release of formaldehyde and acetaldehyde confined in the natural leather and also to fix in place the fibers at the back of the natural leather) is coated to the back of the natural leather already containing the aforementioned treatment agents, and this inhibits and prevents release from the leather of formaldehyde and acetaldehyde that breaks free as a result of breakdown occurring in the natural leather or breakdown of a substance taken into the natural leather, and also fixes in place the fibers at the back of the natural leather.
(2) The aforementioned newly discovered means for treatment encompasses two new points:
   (i) When the back of the natural leather is coated with a back sizing agent containing a hydrazide compound or a hydrazide compound and synthetic resin, separation and release of formaldehyde and acetaldehyde from the leather can be inhibited and prevented.
   (ii) In the manufacturing process of natural leather, a set of tanning agent, synthetic tanning agent, dye and greasing agent are introduced to both sides of the natural leather, and consequently formaldehyde and acetaldehyde generate from such leather. To inhibit and prevent formaldehyde and acetaldehyde from separating and releasing from the leather, a back sizing agent is coated only to the back of the natural leather, as doing so can sufficiently inhibit and prevent separation and release of formaldehyde and acetaldehyde from the leather and thereby achieve the aforementioned purpose. Since the entire amount of the supplied hydrazide compound is taken into the leather, the hydrazide compound can be used more effectively than any method where the leather is soaked in a hydrazide compound solution, and also because the back filling step is used which is an existing step in the leather manufacturing process, it is not necessary to add any new specific step to treat aldehyde and this is very efficient.
(3) By using a natural leather treated according to the present invention, a natural leather that maximally inhibits generation of health-affecting formaldehyde and acetaldehyde can be obtained, and such leather can be safely used for automobile interior parts.

### Effects of the Invention

According to the present invention, a natural leather can be obtained that can maximally inhibit generation of formaldehyde and acetaldehyde to prevent leakage of formaldehyde, acetaldehyde, etc., that break free and generate from the natural leather, where the fibers at the back of the natural leather are also fixed in place.

The present invention also reduces the cost and time needed to obtain a natural leather.

A natural leather obtained according to the present invention can solve problems traditionally associated with leathers obtained through treatment steps using synthetic tanning agents, dyes, greasing agents, etc.

The present invention provides a leather that maximally inhibits generation of health-affecting formaldehyde and acetaldehyde and thus can be safely used for automobile interior parts.

### BRIEF DESCRIPTION OF THE DRAWINGS

FIG. 1 shows a process comprising mainly a tanning step.

FIG. 2 shows a process comprising mainly re-tanning, dyeing, greasing and drying steps.

FIG. 3 shows a process comprising mainly a coating step.

### BEST MODE FOR CARRYING OUT THE INVENTION

Natural leathers manufactured by a traditional manufacturing process of natural leather are often associated with generation of formaldehyde and acetaldehyde as a result of the natural leather taking in various treatment agents used in the manufacturing process of natural leather. Such phenomenon is not desirable for anyone who uses a natural leather or is involved in the manufacturing of a natural leather, and improvements must be made as soon as possible.

The present invention aims to maximally inhibit generation of formaldehyde and acetaldehyde from natural leathers where generation of formaldehyde and acetaldehyde is otherwise expected.

As mentioned above, natural leathers are manufactured through many steps. In these steps, treatment agents supplied for leather manufacturing purposes are taken into the natural leather by means of permeation into all or specific areas of the leather. These agents may not only be adsorbed and retained, but they may also undergo chemical reactions to bond together and become fixed. It is also possible that substances in the leather break down.

Currently it is not clear which treatment agents are directly associated with generation of formaldehyde and acetaldehyde, nor is it clear whether generation of formaldehyde and acetaldehyde depends on lipid or other substances found in the material hide or is due to constituents already present in the leather from the beginning or treatment agents that have bonded with any such constituents in the leather.

In consideration of the above, the present invention solved the aforementioned object by providing a natural leather, wherein such natural leather is obtained by treating a natural leather with a tanning agent, re-tanning agent, dyeing agent and greasing agent so that these treatment agents are taken into the leather, after which a back sizing agent containing a hydrazide compound is coated to the back of the natural leather to prevent generation of formaldehyde and acetaldehyde confined in the natural leather and also to fix in place the fibers at the back of the natural leather.

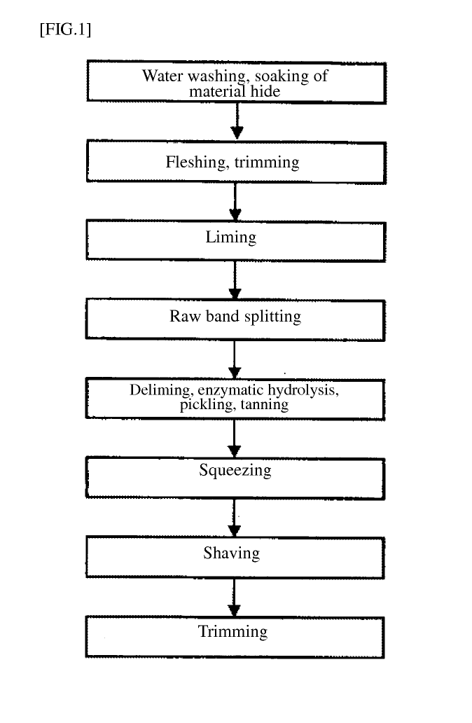

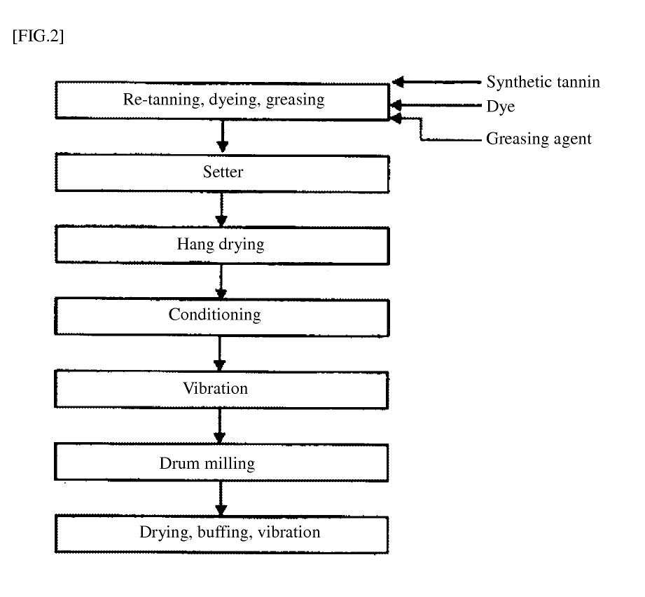

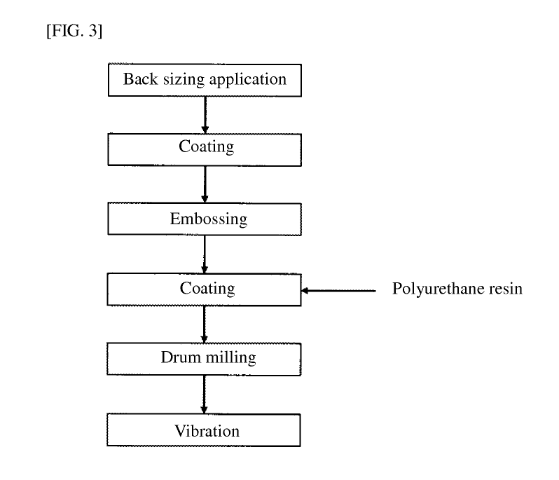

Accordingly, the series of steps to manufacture a natural leather conforming to the present invention involve a process comprising mainly a tanning step (FIG. 1), process comprising mainly re-tanning, dyeing, greasing and drying steps (FIG. 2) and process comprising mainly a step to apply/coat a back filler (FIG. 3).

Now, these series of steps to manufacture a natural leather are explained, with detailed explanations given regarding the step to coat the back of the natural leather to prevent generation of formaldehyde and acetaldehyde confined in the natural leather and to fix in place the fibers at the back of the natural leather.

The process that comprises mainly a tanning step includes a series of steps from a pre-treatment step of water washing and soaking of material hide to a trimming step. (FIG. 1)

In the water washing/soaking step for material hide, the material hide that has been stored at low temperature to maintain freshness and prevent decay is transferred into the lime drum, where water is added to the salt-cured material hide to bring it back to the state of raw hide, and then salt and impurities are removed and pH is adjusted for liming.

In the fleshing/trimming step, the material hide is transferred onto the fleshing machine and trimming machine, where excess fat and other gluey substances are mechanically removed, along with salt and impurities, and then the edges are trimmed. In the liming step, the material hide is transferred into the lime drum, where hairs on the surface of hide are dissolved and scudding is implemented, after which lime is permeated into the hide to loosen the fibers.

In the raw band splitting step, the material hide is transferred onto the band machine, where the hide is strained to a thickness appropriate for the specific purpose and also split into the surface layer and base.

The deliming, enzymatic hydrolysis and pickling steps are as follows.

Limes from the aforementioned liming step are removed, enzymatic hydrolysis is implemented using an enzyme, and the material hide is pickled.

In the tanning step, a tanning agent is supplied as a treatment agent and the obtained hide is tanned with the tanning agent to manufacture a leather.

In the squeezing step, the leather is transferred into the water draining machine to squeeze the leather. Next, squeezed leathers are sorted and graded according to their surface conditions such as presence of flaws or holes, area, etc.

In the shaving step, the leather is transferred onto the shaving machine to shave it to a thickness appropriate for the specific purpose. In the trimming step, unnecessary waste parts, breaks, etc., are cut from the leather edges on the trimming table to prevent breakage and thereby increase work efficiency in the subsequent steps.

The tanning step is where the hide is treated in the presence of a tanning agent and water under an acid condition. The tanning agent induces cross-linking in the collagen substance in the hide and gives resistance to heat, microorganisms and chemical substances, as well as flexibility, to the hide.

For the tanning agent, a trivalent chromium complex such as a chromium compound using a hexaaqua crystal sulfate expressed by Cr₂(SO₄)₃ or an aldehyde compound including glutaraldehyde is used. These substances are traditionally known as tanning agents and any appropriate product available on the market can be purchased and used.

Examples of chromium complex products include the following: ChromitanB, ChromitanMS, ChromitanFM, BaychromaCH, BaychromaCL, BlancorolRN, BlancorolRC, etc.

In the tanning step, chromium salt containing 2 to 2.5% of Cr₂O₃ relative to the untreated hide is introduced, but reportedly 70 to 80% of it is not only fixed in the hide and 20 to 30% is released into the spillage.

This glutaraldehyde is explained below.

Glutaraldehyde is a known substance and if a glutaraldehyde product available on the market is to be used, Relugan GT-50, Relugan GTW, Ucar Tanning Agent GA-25, Ucar Tanning Agent GA-50, etc., can be used.

The use quantity of glutaraldehyde is approx. 1 to 10 percent by weight relative to the weight of leather (Japanese Patent Laid-open No. Hei 08-232000).

All of these tanning agents chemically bind with the components of leather.

In addition to the above, synthetic tanning agents (synthetic tanning agents are explained in connection with the re-tanning step) and vegetable tannins (MimosaME, MimosaFE, Quebracho, etc.) can be used. These substances are traditionally known as tanning agents and any appropriate product available on the market can be purchased and used.

The re-tanning step, dyeing step and greasing step are performed in the same drum.

When each step ends, thorough water wash is performed to prevent the result of the preceding step from affecting the next step. (FIG. 2)

In the re-tanning step, a synthetic tanning agent, vegetable tanning agent, etc., is used as a re-tanning agent. In some cases, the aforementioned tanning agents such as chromium, glutaraldehyde, etc., may be added.

Neutralization is confirmed before re-tanning. To be specific, a pH indicator is dripped onto a cross-section of the leather and how the color change is observed. As a rough guide, the surface layer should have a pH value of around 5 or 6, and inner layer 3 to 4, for the upper leather type.

(1) As for synthetic tanning agents, the following tanning agents are used:

Formaldehyde condensation product of aromatic sulfonic acid (mainly naphthalene or phenol sulfonic acid) and formaldehyde condensation product of amino compound, the details of which are explained below:

(i) Known examples of the formaldehyde condensation product of phenol sulfonic acid are as follows:
(a) Condensate a mixture of phenol sulfonic acid and bishydroxyphenylsulfone at a mol ratio of 1:3, with 2 mol of formaldehyde, in an aqueous solution of pH 6 to 9 at 100 to 120° C., and then the obtained condensation product is adjusted to a pH of 3.5 using sulfuric acid and acid number (AN) of 120 using phthalic acid, and then dried.
(b) Mix sodium salt of phenolsulfonic acid (65% solution) with bis hydroxy phenyl sulfone (55% suspension) at a mol ratio of 2.5:1. Add 2.5 equivalent of formaldehyde (30% solution) to the mixture at high temperature and cause condensation for 3 hours at 112 to 115° C. The obtained rough condensation product is adjusted to an AN of 100 using adipic acid, and then dried.
   When the molecular weight distribution of the formaldehyde condensation product of phenol sulfonic acid was measured by gel chromatography developed with an organic solvent, molecular weights were distributed in a range of Mw400 to 4000 and the center was around Mw3000.
   Any of the following commercial products can be purchased and used.
   Formaldehyde polycondensation product of phenol sulfonic acid: Basyntan DLX-N, MLB, SL, SW Liquid, Tamol NNOL (manufactured by BASF), Tanigan WLF (manufactured by LANXESS)

(ii) Formaldehyde condensation product of naphthalene sulfonic acid
(a) Sulfonate 1.4 H₂SO₄ equivalent of naphthalene for 2 hours at 145° C. Take 1,000 g of the obtained naphthalenesulfonic acid mixture and add 800 g of bishydroxyphenylsulfone and 250 ml of 37% formaldehyde solution, and cause condensation for 3 hours at 100 to 120° C. The obtained product is adjusted to a pH of 3.5 and AN of 80 using sodium hydroxide solution and phthalic acid, and then spray dried (DE-A-10002048, Example 1).
   Another manufacturing method is as follows.
(b) Sulfonate 1.4 H₂SO₄ mol of naphthalene for 3 hours at 145° C., and then cause it to condensate with 0.66 mol of formaldehyde for 3 hours, after which the obtained product is cooled and adjusted to a pH of 3.5, and AN of 50 using sodium hydroxide solution and glutaric acid, and then spray dried (DE-A-10002048, Example 3).
   When the molecular weight distribution of each of these products was measured by gel chromatography developed with an organic solvent, molecular weights were distributed in a range of Mw200 to 2000 and the center was around Mw1300.
   Any of the following commercial products can be purchased and used.
   Formaldehyde polycondensation product of naphthalenesulfonic acid: Basyntan FC, Tamol NA (manufactured by BASF), Ukatan GM (manufactured by Schill+Seilacher), Tanigan BN (manufactured by LANXESS), Irgatan LV (manufactured by TLF), BELLCOTAN A, PT, PS (manufactured by Nippon Fine Chemical)

(iii) Formaldehyde condensation product of phenolsulfonic acid and urea
Treat 1 mol of phenol, 0.5 mol of sulfuric acid, 1 mol of urea and 0.9 mol of formaldehyde by reacting them under strong acidity at 100 to 110° C., and the obtained condensation product is buffered with 0.2 mol of sodium hydroxide solution. The obtained intermediate product is further condensated with 0.8 mol of phenol and 1.2 mol of formaldehyde, after which the obtained product is cooled and adjusted to a pH of 3.5 and AN of 80 using sodium hydroxide solution, formic acid and phthalic acid, and then spray dried.
If a commercial product is to be used, Basyntan (registered trademark) DLX) can be purchased and used.
(2) Using a resin tanning agent

The main component is a condensation product of urea, dicyan diamide, melamine or other amino compound with formaldehyde.

For mixtures of melamine formaldehyde condensation product and urea formaldehyde condensation product, Relugan D, DLF or S (manufactured by BASF), etc., can be used.

For polyacrylic acid resin tanning agents, ReluganSE, RE, RV (manufactured by BASF), LuburitanGX (Rohm and Haas), etc., can be used.

In the re-tanning step, the synthetic tanning agent or other tanning agent used should be present as an aqueous solution containing, preferably, 50 to 200 percent by weight of water relative to the wet weight of the shaved leather (leather completing the shaving step and trimming step) used.

The condition for such tanning agent should be pH 3.0 to 8.0, or more preferably 3.5 to 6.5. The re-tanning time should be preferably 1.5 to 24 hours, or more preferably 2 to 8 hours.

In the dyeing step, the leather is dyed using a dye.

In the dyeing step, a dye or pigment corresponding to the desired color is used.

The leather obtained through the aforementioned treatment method is dyed using an anionic water-based dye. Here, this anionic water-based dye is constituted by a water-based medium, dye, etc. A water-based medium may be water or mixture of water and alcohol or other water-soluble medium. Also note that although any dye can be used as long as it can be used to add color to the leather, representative examples include acid dyes and reactive dyes, among others.

Acid dyes include C. I. Acid Black 1, C. I. Acid Black 26, C. I. Acid Black 52, C. I. Acid

Green 9, C. I. Acid Green 25, C. I. Acid Brown 2, C. I. Acid Brown 13, C. I. Acid Violet 43, C. I. Acid Violet 49, C. I. Acid Orange 7, C. I. Acid Orange 56, C. I. Acid Orange 67, C. I. Acid Blue 40, C. I. Acid Blue 45, C. I. Acid Blue 74, C. I. Acid Blue 92, C. I. Acid Blue 113, C. I. Acid Blue 127, C. I. Acid Blue 185, C. I. Acid Red 18, C. I. Acid Red 27, C. I. Acid Red 52, C. I. Acid Red 82, C. I. Acid Red 87, C. I. Acid Red 114, C. I. Acid Red 186, C. I. Acid Red 266, C. I. Acid Yellow 1, C. I. Acid Yellow 7, C. I. Acid Yellow 23, C. I. Acid Yellow 110, etc.

Reactive dyes include C. I. Acid Black 5, C. I. Acid Brown 1, C. I. Acid Violet 2, C. I. Acid Orange 1, C. I. Acid Orange 2, C. I. Acid Blue 4, C. I. Acid Blue 19, C. I. Acid Red 6, C. I. Acid Red 17, C. I. Acid Yellow 3, C. I. Acid Yellow 17, etc. The aforementioned dyes can be combined. Also, a dye or dyes is/are dissolved and/or dispersed in a water-based medium before application to adjust to a desired color. It is also possible to add pigments or other coloring materials to the extent that it does not inhibit the coloring effect.

As for the dyeing method, the following explains dyeing the surface of an upper leather made of chromium-tanned cowhide of approx. 1.4 mm in thickness.

After the re-tanning, the leather is washed with 400% of water (the wet weight of the shaved leather is hereinafter used as the reference), and the leather is dyed in an aqueous solution constituted by 250% of water (50° C.), 0.5% of level dyeing agent and 2.5% of surface dye (1:20). One half of the step is implemented by 20 minutes of rotation, and the remaining half by 30 minutes of rotation. The fixing operation using 1% of formic acid (1:10) comprises the two-thirds of the step implemented by 10 minutes of rotation, and the remaining one-third by 10 minutes of operation.

In the greasing step, the leather is treated using a greasing agent.

The greasing step is performed after the dyeing step following re-tanning, and designed to add the required flexibility to the leather product by treating the leather with an oil agent called “greasing agent.” Not a few greasing agents have surface activation property. As a result, these agents tend to permeate into the leather easily.

The dyed leather introduced to the greasing step is wet with water, and flexibility of fibers is retained by the water present between the fibers constituting fiber bundles. If this water dries up, fibers will stick together and both the fibers and structure will harden. Accordingly, it is effective to apply an oil agent to the space between fibers, before the water dries, to inhibit sticking of fibers. Also, functions to protect leather fibers (water repellency, water-proofness), touch and bulge are added. This is the purpose of the greasing step, where a greasing agent is used.

Greasing agents include the following, and any one of these may be selected and used.
(1) Anionic greasing agents are as follows.
   (i) Sulfated oil
      Sulfated oil is a natural unsaturated oil that is mixed with sulfuric acid and turned into sulfuric ester. The hydroxyl groups and double bonds are partially sulfated.
      Examples include the following:
      Sulfated aliphatic acid ester: Lipoderm Liquor PU (manufactured by BASF) Synthetic sulfonated lipid: SYNCUROL KV (manufactured by MUNZING) Mixture of sulfonated ester and hydrocarbon: SYNCUROL 79 (manufactured by MUNZING)
      Sulfonated ester: SYNCUROL SE (manufactured by MUNZING) Synthetic sulfonated ester: SYNCUROL PF, MAX (manufactured by MUNZING)
   (ii) Sulfonated oil
      Sulfonated oil is a synthetic oil or natural oil containing unsaturated groups, which is treated with sulfuric anhydride, fuming sulfuric acid, chlorulfonic acid, etc., to neutralize the double bonds in the molecule by means of sulfonation.
      Examples of sulfonated oil include SK Oil HF (manufactured by Sunplus) and Pellastol ES (manufactured by Zschimmer & Schwarz Chemische Fabriken), among others.
      Note that SK Oil HF is a synthetic sulfonated oil with anti-yellowing property and constituted by a mixture of 50 percent by weight of unreacted raw oil, 25 percent by weight of sulfuric ester and 25 percent by weight of hydrolysis product.
      Other examples include Taakon FA-200 (manufactured by Taiko Oil Chemicals), Pelgrassol SF (manufactured by Zschimmer & Schwarz Chemische Fabriken), and the like. Taakon FA-200 is a mixture of, among others, fatty acid monoglyceride, natural sulfonated oil and oxidized products thereof.
   (iii) Sulfited oil
      Sulfited oil is a sulfonate obtained from a highly unsaturated natural oil or synthetic oil, which is treated with sulfite as a sulfonating agent.
      Mixture of sulfited fish oil, natural oil and emulsifier: Lipsol EB (manufactured by MUNZING)
      Sulfited fish oil: OPTIMALIN UPNC (manufactured by MUNZING)
      Water-soluble emulsion of vegetable oil and sulfited animal oil: Lipoderm Liquor A1 (manufactured by BASF)
   (iv) Fatty acid soap
      Fatty acid soap is a soap obtained by saponifying a natural oil using an aqueous alkali solution. Ammonium salt and potassium salt are also used as greasing agents. Since fatty acid breaks free at neutral to acidity, these greasing agents have the effects of surface active agent and neutral oil.
      Denatured fatty acid: Lipoderm Liquor LA (manufactured by BASF)
   (v) Phosphorylated oil
      Egg yolk, soybean lecithin and other phospholipids have been used. Recently, phosphate ester salts of higher alcohol and polyoxy ethylene alkyl ether are widely used forms of phosphorylated oil.
      Emulsion of synthetic oil and lecithin oil mixture: Lipsol LQ (manufactured by Schill+Seilacher)
      Phosphate ester oil: Lipoderm Liquor PU (manufactured by BASF)
      Blend of sulfated vegetable oil, phosphate ester salt of fatty alcohol and hydrocarbon: LIQUOR KIM (Nagi Shokai)
   (vi) Multipolar greasing agents are mixtures of anionic agents, nonionic greasing agents and a small amount of cationic greasing agents.
   (vii) Other anionic greasing agents
      Examples include mono- or di-alkyl succinic acid, alkylmalonic acid, carboxylic acid salt with the alkyl chain at both ends and other substances having complex activation groups, and polyacrylic acid derivatives having long-chain alkyl groups.
   Cationic greasing agents
      For cationic greasing agents, quaternary ammonium salt, aliphatic amine, aliphatic polyamine condensation product are used.
   Amphoteric greasing agents
      For amphoteric greasing agents, lecithin has long been used as a greasing agent having both anionicity and cationicity in the same molecule.
   Nonionic greasing agents
      Nonionic greasing agents are never used alone, but always combined with anionic or cationic greasing agents.
      Aqueous solution of natural oil and nonionic surface active agent: Lipoderm Liquor IC (manufactured by BASF)
      Aqueous solution mixture of wax, natural oil and surface active agent: Lipoderm Liquor SC (manufactured by BASF)
      Aqueous solution of nonionic surface active agent, sulfited oil and sodium salt: Lipoderm Liquor WF (manufactured by BASF)
      Mixture of natural oil, synthetic oil and synthetic emulsifier: Lipsol MSG (manufactured by Schill+Seilacher)
   Neutral oils, specifically (i) animal oil, (ii) marine animal oil, (iii) vegetable oil, (iv) mineral oil, and (v) synthetic oil can be listed.
      These are combined with greasing agents.

In the greasing step, the natural leather completing the dyeing step is treated in the same drum in the presence of a greasing agent and sodium hydrogen sulfite so that when the greasing agent is taken into the natural leather, sodium hydrogen sulfite is also taken into the natural leather and therefore formaldehyde and other substances that are considered to generate due to the greasing agent can be trapped within the leather by the action of sodium hydrogen sulfite.

In this case, the leather is treated under a temperature condition of 50 to 60° C.

Coating step using a back sizing agent

A coating agent proposed by the present invention is an agent to coat the back of a natural leather for the purpose of preventing generation of formaldehyde and acetaldehyde confined in the natural leather and also for the purpose of fixing in place the fibers at the back of the natural leather.

Traditionally this step has been known as a step to coat the back of the natural leather to fix in place the fibers at the back of the natural leather. Under the present invention, however, a new coating step is established based on the new discovery that a hydrazide compound can be used as this agent to coat the back of a natural leather for the purpose of preventing generation of formaldehyde and acetaldehyde confined in the natural leather and also for the purpose of fixing in place the fibers at the back of the natural leather.

In the above, “fixing in place the fibers at the back of the natural leather” refers to a process of coating the back of the natural leather to have the fibers at the back of the leather fixed in place so as to prevent loosening of the fibers and also prevent leathers stacked on top of one another from sticking to the front side of the adjacent natural leather.

Also note that the term “back of the natural leather” is used as oppose to the “front side” where the grain of leather is present. Unlike on the front side, leather fibers at the back are present in a loosened state. When using a natural leather, it is inconvenient that the fibers present at the back become loosened, which necessitates fixing of these fibers in place and a back sizing agent is used for this purpose.

Examples of an agent used under the present invention to coat the back of the natural leather include the following:
(1) Back sizing agent containing a hydrazide compound
(2) Back sizing agent containing a hydrazide compound into which sodium hydrogen sulfite has been mixed
(3) Back sizing agent containing a hydrazide compound into which a synthetic resin has been mixed
(4) Back sizing agent according to (3) above, wherein the synthetic resin is an acrylic resin

In (1) above, the composition of the back sizing agent containing a hydrazide compound is as follows:

Hydrazide compound 1.0 to 7.0 percent by weight

Water 93.0 to 99.0 percent by weight (total 100 percent by weight)

Preferably the hydrazide compound should be contained by 3.0 to 6.0 percent by weight.

A specific example is shown in Example 1.

Between 0.1 to 0.6 g of this coating agent of the aforementioned concentration is coated to the back of 1 DS of leather (10 cm×10 cm) using a roll coating machine (roll coater).

When coating the agent, caution should be exercised not to create mottled appearances. After the coating operation, the leather is heated to 60 to 70° C. to solidify the area where the back filler has been introduced.

The maximum limit of the content of hydrazide compound is 10 percent by weight.

In (2), the composition of the agent to coat the back of the natural leather for the purpose of preventing generation of formaldehyde and acetaldehyde confined in the natural leather and also for the purpose of fixing in place the fibers at the back of the natural leather, wherein sodium hydrogen sulfite is mixed into the aforementioned hydrazide compound, is as follows:
Hydrazide compound 1.0 to 7.0 percent by weight, or preferably 3.0 to 6.0 percent by weight
Sodium bisulfite 0.5 to 7.0 percent by weight
Water 86.0 to 98.5 percent by weight (The total of hydrazide compound and water gives 100 percent by weight. If sodium bisulfite is contained, the amount of water corresponds to the total amount including sodium bisulfite less the content of sodium bisulfite.)

Sodium bisulfite is effective in confining formaldehyde, but it is reportedly not effective in confining acetaldehyde, and the above composition should be used by considering this common knowledge.

Also, preferably the hydrazide compound should be contained by 3.0 to 6.0 percent by weight.

Between 0.1 to 0.6 g of this coating agent of the aforementioned concentration is coated to the back of 1 DS of leather (10 cm×10 cm) using a roll coating machine (roll coater). When coating the agent, caution should be exercised not to create mottled appearances. After the coating operation, the leather is heated to 60 to 70° C. to solidify the area where the back filler has been introduced.

In (3), the composition of the agent to coat the back of the natural leather for the purpose of preventing generation of formaldehyde and acetaldehyde confined in the natural leather and also for the purpose of fixing in place the fibers at the back of the natural leather, wherein a synthetic resin is mixed into the hydrazide compound, and of the agent in (4) to coat the back of the natural leather for the purpose of preventing generation of formaldehyde and acetaldehyde confined in the natural leather and also for the purpose of fixing in place the fibers at the back of the natural leather, wherein such agent is the same as the one according to (3) except that the synthetic resin is acrylic resin, is as follows:
Hydrazide compound 1.0 to 7.0 percent by weight, or preferably 3.0 to 6.0 percent by weight
Resin (or acrylic resin) More than 0 to 30 percent by weight, or preferably 20 to 30 percent by weight
Water 99.0 to 63.0 percent by weight (total 100 percent by weight)

The agent can also contain sodium bisulfit for the same reason explained above.

Also, preferably the hydrazide compound should be contained by 3.0 to 6.0 percent by weight.

Preferably the resin (or acrylic resin) should be contained by 20 to 30 percent by weight. Between 0.1 to 0.6 g of this coating agent of the aforementioned concentration is coated to the back of 1 DS of leather (10 cm×10 cm) using a roll coating machine. When coating the agent, caution should be exercised not to create mottled appearances. After the coating operation, the leather is heated to 60 to 70° C. to solidify the area where the back filler has been introduced.

The aforementioned synthetic resin is explained below.

Presence of a synthetic resin helps fix the fibers at the back of the natural leather more effectively in place compared to when only a hydrazide compound is used. Examples of such resin include those exhibiting adhesive property such as acrylic resin, polyurethane resin, epoxy resin, polyphenol, polyvinyl alcohol, polyvinyl chloride, copolymer of vinyl chloride and acrylate ester, polymethacrylate ester, polyvinyl alcohol, polybutadiene, polystyrol, copolymer of styrol and butadiene, and casein. Among these, acrylic resin is most preferred.

These resins are dispersed well in water and any back sizing agent containing any one of these resins can be used as long as it can fix in place the fibers at the back of the natural leather. All resins are known substances.

In the manufacturing process of natural leather, coating a back filler to the natural leather provides a desirable kind of natural leather as explained below.

In other words, a natural leather can be obtained that has been treated with, and has thereby taken in, a tanning agent, re-tanning agent, dyeing agent and greasing agent, and then coated with an agent on its back to prevent generation of formaldehyde and acetaldehyde confined in the above natural leather and also to fix in place the fibers at the back of the natural leather.

The specifics are as follows:
(1) A leather obtained by treating the material leather with a tanning agent, re-tanning agent, dyeing agent and greasing agent so that these agents are taken into all areas of the leather, and then coating the back of the leather with a back sizing agent for natural leather where such agent contains a hydrazide compound.
(2) A leather obtained by treating the material leather with a tanning agent, re-tanning agent, dyeing agent and greasing agent so that these agents are taken into all areas of the leather, and then coating the back of the leather with a back sizing agent for natural leather where such agent contains a hydrazide compound and synthetic resin.

In the leather manufacturing process according to (1) and (2), the treatment using the aforementioned greasing agent can be performed in the presence of an aqueous sodium hydrogen sulfite solution so as to take sodium hydrogen sulfite, together with the greasing agent, into the natural leather being treated, in order to inhibit and prevent generation of formaldehyde.

This natural leather can trap within the natural leather the formaldehyde and acetaldehyde confined in the natural leather in order to inhibit and prevent generation thereof and also fix in place the fibers at the back of the natural leather.

The applicants for the patent involving the present invention have also confirmed that one method to effectively trap formaldehyde and acetaldehyde within the leather is to use a treatment agent containing sodium hydrogen sulfite in the greasing step. Accordingly, the applicants have confirmed that it is also effective, under the present invention, to perform the greasing step in the presence of a treatment agent containing sodium hydrogen sulfite and then further apply a back sizing agent for natural leather containing a hydrazide compound, or back sizing agent for natural leather containing a hydrazide compound and polyacrylic resin, in the back filling process.

The aforementioned hydrazide compound is not specifically limited, and examples include monohydrazide compounds having one hydrazide group in the molecule, dihydrazide compounds having two hydrazide groups in the molecule, and polyhydrazide compounds having three or more hydrazide groups in the molecule, among others.

Specific examples of monohydrazide compounds include those expressed by General Formula (1):

[Chemical Formula 1]

R—CO—NHNH₂ (1)

(In the formula, R represents a hydrogen atom, alkyl group or aryl group that can have a substitutional group.)

In General Formula (1) above, an alkyl group represented by R may be, for example, a methyl group, ethyl group, n-propyl group, n-butyl group, n-pentyl group, n-hexyl group, n-heptyl group, n-octyl group, n-nonyl group, n-decyl group, n-undecyl group or other straight-chain alkyl group with 1 to 12 carbons. If it is an aryl group, examples include a phenyl group, biphenyl group and naphthyl group, among others. Of these, use of a phenyl group is preferable. A substitutional group any such aryl group can have may be, for example, a hydroxyl group, fluorine, chlorine, bromine or other halogen atom, methyl group, ethyl group, n-propyl group, iso-propyl group, n-butyl group, tert-butyl group, iso-butyl group or other straight- or branched-chain alkyl group with 1 to 4 carbons.

More specifically, a hydrazide compound expressed by General Formula (1) above may be, for example, lauric acid hydrazide, salicylic acid hydrazide, formhydrazide, acetohydrazide, propionic acid hydrazide, p-hydroxy benzoic acid hydrazide, naphthoic acid hydrazide or 3-hydroxy-2-naphthoic acid hydrazide, among others.

Specific examples of dihydrazide compounds include those expressed by General Formula (2):

[Chemical Formula 2]

H₂NHN—X—NHNH₂ (2)

(In the formula, X represents group-CO— or group-CO-A-CO—. A represents an alkylene group or arylene group.)

In General Formula (2) above, an alkylene group represented by A may be, for example, a methylene group, ethylene group, trimethylene group, tetramethylene group, pentamethylene group, hexamethylene group, heptamethylene group, octamethylene group, nonamethylene group, decamethylene group, undecamethylene group or other straight-chain alkylene group with 1 to 12 carbons. Examples of an arylene group include, among others, a phenylene group, biphenylene group, naphthylene group, anthrylene group and phenanthrylene group. Of these, use of a phenylene group, naphthylene group, etc., is preferable. A substitutional group any such arylene group can have may be selected from the same examples of substitutional groups cited for the aforementioned aryl group.

To be specific, a dihydrazide compound expressed by General Formula (2) above may be, for example, an oxalic acid dihydrazide, malonic acid dihydrazide, succinic acid dihydrazide, adipic acid dihydrazide, azelaic acid dihydrazide, sebacic acid dihydrazide, dodecanedioic acid dihydrazide, maleic acid dihydrazide, fumaric acid dihydrazide, diglycolic acid dihydrazide, tartaric acid dihydrazide, malic acid dihydrazide, isophthalic acid dihydrazide, terelthalic acid dihydrazide, dimeric acid dihydrazide, 2,6-naphthoic acid dihydrazide and other dibasic acid dihydrazides.

Furthermore, the various dibasic acid dihydrazide compounds described in Examined Japanese Patent Laid-open No. Hei 2-4607, and 2,4-dihydrazide-6-methyl amino-sym-triazine, etc., can also be used as dihydrazides for the aforementioned purpose.

Among these, a dihydrazide compound is preferable and dibasic acid dihydrazide is particularly preferable, where adipic acid dihydrazide associated with the fastest adsorption speed is most preferable. Also note that adipic acid dihydrazide is soluble in water and does not volatilize easily, so it dissolves and disperses well in rubber emulsion as explained later.

Furthermore, adipic acid dihydrazide offers the advantage of becoming less volatile after having being adsorbed in leather, meaning that its adsorption ability will be sustained for an extended period of time. For your information, one type of the aforementioned hydrazide compound can be used alone or two or more types can be mixed.

Known products include Chemcatch by Otsuka Chemical, which can be purchased and used for the aforementioned purpose.

The coating film step is implemented after the step (=back filling step) where a back sizing agent for natural leather, designed to fix in place the fibers at the back of the natural leather, is coated to the back of the leather and injected into the leather.

A base coat layer constituted by a water-based coating agent containing pigment is coated onto the surface of the base of the natural leather thus obtained, a color coat layer constituted by a water-based coating agent is coated onto the aforementioned coat layer, and a topcoat layer is formed on the aforementioned coat layer.

(1) Application of base coat
The base coat layer is the bottom layer constituting the layered coating film, used to flatten the surface irregularities of the leather and thereby prepare the leather surface for forming of stable layers on top. To form this layer, a composition constituted by resin, pigment, auxiliaries, touch agent, leveling agent and water is applied onto the leather surface. For the resin, a two-component polyurethane resin is used. For the pigment, a pigment of a desired color is used. For the pigment, a pigment of a desired color is used. For the auxiliaries, various agents can be used including surface active agent, thickening agent, adjustment agent and matte agent. The application method can be selected from among brushing, spraying, curtain-coating and roll-coating of an aqueous solution of the mixture, as deemed appropriate. The application amount is 70 to 150 g/m², and hot air is blown onto the coated surface to evaporate the water content. The film thickness is 20 to 50 μm.
This is followed by embossing. Embossing is a type of processing whereby concave/convex shapes are added to the leather surface using a high-pressure press so that the leather will have various patterns (grain patterns). Next, the leather goes through the drum milling step and staking step to loosen the leather fibers and adjust its texture.

(2) Application of color coat
A color coat is formed on the base coat surface. The color coat layer is the intermediate layer in the coating film, provided on top of the base coat formed on the leather, and the pigment/dye used to add color to the leather is contained in this layer. To form this layer, again a composition constituted by resin, pigment, auxiliaries, cross-linking agent, touch agent and water is applied onto the leather surface. For the resin, a two-component polyurethane resin is used. For the pigment, a pigment of a desired color is used. For the auxiliaries, various agents can be used including surface active agent (leveling agent, etc.), thickening agent and adjustment agent. The application method can be selected from among brushing, spraying, curtain-coating and roll-coating of an aqueous solution of the mixture, as deemed appropriate. The application amount is 20 to 70 g/m², and hot air is blown onto the coated surface to evaporate the water content. The film thickness is 5 to 25 μm.

(3) Application of topcoat
A topcoat is formed on the color coat surface. The topcoat layer is the top layer in the coating film and adds durability such as wear resistance, good appearance (color, gloss) and touch. To form this topcoat layer, a water-based composition containing resin, cross-linking agent, delustering agent, pigment and touch agent is used. For the resin, a two-component polyurethane resin, acrylic resin, etc., can be used. The application method can be selected from among brushing, spraying, curtain-coating and roll-coating of an aqueous solution of the mixture, as deemed appropriate. The application amount is 20 to 70 g/m², and hot air is blown onto the coated surface to evaporate the water content. The film thickness is 5 to 25 μm.

Generation of formaldehyde or acetaldehyde from the polyurethane resin, acrylic resin, pigment and touch agent (polysiloxane type) used in this step is also not practicable based on the chemical common sense.

Accordingly, all that is required is to provide a treatment for preventing generation of formaldehyde and acetaldehyde to the aforementioned leather on which layers have been formed using treatment agents through the re-tanning, dyeing and greasing steps.

The leather manufactured through the aforementioned steps was tested by the method explained below to check if formaldehyde and acetaldehyde would be detected.

In the examples of the present invention, formaldehyde and acetaldehyde were analyzed using the Tedlar bag method.

Under the Tedlar bag method, the sample leather is cut to the size of 1 DS (10 cm x 10 cm) and put in a Tedlar bag, after which nitrogen is charged and the bag is sealed. The bag is then heated to cause aldehydes to volatilize from the leather. In this condition, a pump is used to suction the gas out of the bag and let aldehydes be adsorbed by a special dinitrophenyl hydrazide (DNPH) cartridge. The adsorbed substances are then eluted using acetonitrile and the obtained solution is measured by high-speed liquid chromatography.

### Example 1

The results of examining the effectiveness of various aldehyde trapping agents in reducing the volatilization amount of aldehyde are shown below.

The chemical agents used in the tanning, re-tanning, dyeing and greasing steps are explained below. In the tanning step, the following amount of tanning agent remained in the leather:

Chromium: 3.0%, as chromium oxide

The re-tanning/dyeing steps are explained below.
(1) The following amount of each re-tanning agent remained in the leather:
   (i) Amount remaining in the leather of a synthetic tanning agent using a methylene cyclic polymer of aryl sulfonic acid and hydroxy aryl sulfone (3 parts by weight relative to 100 parts by dry weight of leather)
   (ii) Amount remaining in the leather of a synthetic tanning agent using a methylene cyclic polymer of carboxylic amide and hydroxy aryl sulfone (3 parts by weight relative to 100 parts by dry weight of leather)
   (iii) Amount of a resin tanning agent remaining in the leather (3 parts by weight relative to 100 parts by dry weight of leather)
(2) Dye
   (i) Dye (including carbon black)
      Amount of a dye remaining in the leather (5 parts by weight relative to 100 parts by dry weight of leather)

The greasing step is explained below.
(1) Amount of greasing agent added
   Greasing agent used: Mixture of natural oil and synthetic oil
   Amount of greasing agent used: 6.5 (parts by weight relative to 100 parts by wet weight of leather)
   Treatment temperature: 50 to 60° C.
   pH: 5
(2) Sodium hydrogen sulfite 1 (part by weight relative to 100 parts by wet weight of leather)
   The thickness of the leather tested after the greasing step and drying was approx. 1.1 mm, while the weight was approx. 7.7 g per 1 DS.

The aldehyde trapping agent used in the test, and its concentration, are explained below.

Each aldehyde trapping agent was used in the form of an aqueous solution, and water was used as the control.

(1) Dihydrazide compound
(i) Adipic acid dihydrazide: 1, 3, 5, 10 and 12.5 percent by weight
(ii) Carbohydrazide: 10 percent by weight

(2) Urea: 10 percent by weight

(3) Hydrochloric acid guanidine: 10 percent by weight
A spray was used to apply each aqueous solution of aldehyde trapping agent to the back side of the leather by 0.56 g per 1 DS (10 cm×10 cm), after which the leather was dried at 60 to 80° C. for 4 to 6 hours. The content of aldehyde trapping agent in the leather was 0.73 part by weight relative to 100 parts by weight of leather when the aldehyde trapping agent had a concentration of 10%.

The obtained natural leather was confirmed to have its fibers fixed at the back of the natural leather due to coating of a back sizing agent conforming to the present invention.

It was also confirmed, as explained below, that generation of formaldehyde and acetaldehyde confined in the natural leather was inhibited and prevented. Table 1 shows the results of measurement of volatilization amounts of formaldehyde and acetaldehyde.

TABLE 1

| Back sizing agent | | | | |
|---|---|---|---|---|
| | Concentration | Volatilization amount of | | |
| | (percent by | aldehyde (μg/DS) | | Precipitation of |
| Type | weight) | Formaldehyde | Acetaldehyde | back sizing agent |
| Control | 0 | 0.65 | 4.5 | — |
| ADH | 1 | 0.65 | 0.75 | Not detected |
| | 3 | 0.28 | 0.41 | Not detected |
| | 5 | 0.32 | 0.21 | Not detected |
| | 10 | 0.43 | 0.1 | Detected |
| | 12.5 | 0.36 | 0.03 | Detected |
| Comparative Example | 10 | ND | 0.01 | Not detected |
| Carbohydrazide | | | | |
| Comparative Example | 10 | 0.17 | 4.8 | Not detected |
| Urea | | | | |
| Comparative Example | 10 | 0.5 | 4.86 | Not detected |
| Hydrochloric acid guanidine | | | | |

In Table 1, ADH stands for “adipic acid dihydrazide.”

ND means that the measured volatilization amount of aldehyde was negative (=the measured value of the sample was lower than the measured value of the control based on the Tedlar bag method).

The results in Table 1 show that ADH was able to reduce the volatilization amounts of both formaldehyde and acetaldehyde.

In particular, favorable results were obtained at concentrations of 3 percent by weight and above.

At a concentration of 10 percent by weight, ADH precipitated after drying and white powder attached to the back side of the leather, thus producing a leather which would make defective leather products.

Since attachment of white powder was still observed at a concentration of 7 percent by weight, a range of concentrations of aqueous solution of ADH at which ADH can be used favorably is 3 to 6 percent by weight.

Like ADH, carbohydrazide also produced favorable results. However, use of carbohydrazide presents safety problems because it is explosive.

As for urea, only formaldehyde was reduced in a favorable manner. Hydrochloric acid guanidine had little effect.

Based on the above results, ADH is shown to be the best aldehyde trapping agent.

### Example 2

The results of examining the effectiveness of coating a back sizing agent into which ADH is mixed, and impact of coating the surface with polyurethane, are shown below.
(1) Leather used
   The leather was prepared in the same manner as in Example 1. The weight per 1 DS was 7.7 g, volatilization amount of formaldehyde was ND, and volatilization amount of acetaldehyde was 6.86 μg/DS.
   Back sizing agent (back sizing agent for natural leather)
(2) Coating of back sizing agent and formation of coating film
   For the base back sizing agent (control), a water-based emulsion of polyacrylic resin (solid content of polyacrylic resin: 17%) was used. ADH was added to the base back sizing agent so that its content became 7 percent by weight, and the agent was agitated to dissolve ADH.
   A roll coater was used to coat the back sizing agent on the back side of dry leather by 0.56 g per 1 DS, after which the leather was dried at 80° C. for 1 hour and then a base coat, color coat and topcoat were applied on the surface.
   The ADH content of the leather coated with ADH was 0.5 part by weight relative to 100 parts by weight of leather.
(3) Results
   The measured amounts of aldehyde volatilization are shown below.
   Following the coating of the back sizing agent, volatilization amounts of formaldehyde and acetaldehyde were measured before and after coating the surface. The results are shown in Table 2.

TABLE 2

| | Volatilization amount of aldehyde (μg/DS) | | | |
|---|---|---|---|---|
| | Formaldehyde | | Acetaldehyde | |
| | Control | | Control | |
| | (ADH 0 | ADH | (ADH 0 | ADH |
| | percent | 7 percent by | percent | 7 percent by |
| Step | by weight) | weight | by weight) | weight |
| Before coating | ND | | 6.86 | |
| the back sizing | | | | |
| agent | | | | |
| After coating the | ND | 0.01 | 3.48 | 0.3 |
| back sizing agent | | | | |
| After coating the | 0.05 | ND | 5.67 | 0.26 |
| surface | | | | |

The volatilization amount of formaldehyde did not increase after the coating.

The volatilization of acetaldehyde decreased significantly after the coating of ADH, and decreased slightly after the surface was coated.

Table 3 shows the solubility of ADH in the back sizing agent in which it was contained (water-based emulsion of acrylic resin whose solid content of acrylic resin is 16 percent by weight).

TABLE 3

| | Temperature | ADH Concentration (percent by weight) | | | | | | | | |
|---|---|---|---|---|---|---|---|---|---|---|
| Solvent | (° C.) | 1 | 3 | 5 | 6 | 7 | 9 | 10 | 12 | 13 |
| Water | 4 | ◯ | ◯ | ◯ | ◯ | X | X | X | X | X |
| | 20 | ◯ | ◯ | ◯ | ◯ | ◯ | ◯ | ◯ | ◯ | X |
| Back sizing | 4 | ◯ | ◯ | ◯ | ◯ | ◯ | X | X | X | X |
| agent | 20 | ◯ | ◯ | ◯ | ◯ | ◯ | ◯ | ◯ | X | X |

In Table 3, “◯” indicates that ADH dissolved completely, while “X” indicates that ADH did not dissolve completely. The maximum dissolution limit of ADH in water was 12 percent by weight at a liquid temperature of 20° C. and 6 percent by weight at 4° C. The maximum dissolution limit of ADH in the back sizing agent was 10 percent by weight at a liquid temperature of 20° C. and 7 percent by weight at 4° C. With both solvents, clearly ADH dissolves instantly at lower concentrations and takes time to dissolve at higher concentrations.

If an aqueous solution of ADH or back sizing agent containing ADH is coated on the back side of the leather when ADH has not yet dissolved fully, problems will occur such as attachment of powder to the leather.

Note that when ADH is dissolved in a back sizing agent, powder does not precipitate onto the dried leather, even at a concentration of 10 parts by weight, which is different from when ADH is dissolved in an aqueous solution.

### Example 3

The effects of treating the leather with sodium hydrogen sulfite in the greasing step, and with ADH in the back filling step, are explained.
(1) Leather used
   The leather was prepared in the same manner as in Example 1. To examine the effects of ADH alone, however, leather samples were prepared with and without using sodium hydrogen sulfite in the greasing step.
(2) Coating of back sizing agent
   The back sizing agent (back sizing agent for natural leather) is explained below.
   To the base back sizing agent (control=water-based emulsion of polyacrylic resin (solid content of polyacrylic resin: 17%)), ADH was added to the contents of 1, 3, 5, 7 and 10 percent by weight.
   The following explains the coating and drying of the back sizing agent.
   A roll coater was used to coat the back sizing agent on the back side of the leather at a coating amount of 0.56 g/DS, after which the leather was dried at 80° C. for 1 hour.
(3) Results
   Table 4 shows the measured results of volatilization amounts of formaldehyde and acetaldehyde.

TABLE 4

| | Volatilization amount of aldehyde (μg/DS) | | | |
|---|---|---|---|---|
| | Formaldehyde | | Acetaldehyde | |
| | Not | | Not | |
| Back sizing | treated with | Treated with | treated with | Treated with |
| agent, ADH | sodium | 1% sodium | sodium | 1% sodium |
| (parts by | hydrogen | hydrogen | hydrogen | hydrogen |
| weight) | sulfite | sulfite | sulfite | sulfite |
| 0 | 0.29 | 0.05 | 0.46 | 0.41 |
| 1 | ND | 0.01 | 0.25 | 0.31 |
| 3 | 0.02 | ND | 0.13 | 0.16 |
| 5 | ND | 0.02 | 0.03 | 0.05 |
| 7 | 0.02 | 0.12 | 0.1 | 0.03 |
| 10 | 0.16 | 0.04 | 0.07 | 0.09 |

Clearly sodium hydrogen sulfite is effective, particularly on formaldehyde, whereas its effect of reducing the volatilization amount of acetaldehyde is small.

ADH is shown to be effective on both, capable of reducing the volatilization amounts of formaldehyde and acetaldehyde by itself.

In this example, the amount of acetaldehyde decreased as the added amount of ADH increased, until saturation occurred when 5 to 7 percent by weight of ADH was added.

### Example 4

The results on chromium-free leather are shown below.
(1) Leather

used

(i) Chromium-free leather
Chromium-free leather refers to a type of leather that does not contain chromium and is therefore easy to incinerate. It is prepared by treating the leather with glutaraldehyde, without using chromium, in the tanning step, and then treating it with a lot of vegetable tannin agent and greasing agent in the re-tanning step.
Amount of vegetable tannin agent remaining in the leather: 21 (parts by weight relative to 100 parts by dry weight of leather)
Amount of greasing agent remaining in the leather: 16 (same as above)
The leather was treated with 1% sodium hydrogen sulfite in the greasing step.

(b) Chromium-containing leather
For comparison purposes, chromium-containing leather samples prepared in the same manner as in Example 1 were also tested.
(2) Coating of back sizing agent

The composition of the back sizing agent is explained below.

For the base back sizing agent (control), a water-based emulsion of polyacrylic resin (solid content of polyacrylic resin: 17%) was used. ADH was added to the base back sizing agent so that its content became 7 percent by weight. A roll coater was used to coat the back sizing agent on the back side of the leather by 0.56 g/DS, after which the leather was dried at 60° C. for 1 hour. The ADH content in the leather (relative to 100 parts by weight of leather) was 0.5 part by weight with both chromium-containing and chromium-free leathers.
(3) Results

The measured results of volatilization amounts of formaldehyde and acetaldehyde are shown in Table 5.

TABLE 5

| | Volatilization amount of aldehyde (μg/DS) | | | |
|---|---|---|---|---|
| | Formaldehyde | | Acetaldehyde | |
| | Control | | Control | |
| | (ADH 0 | ADH | (ADH 0 | ADH |
| | percent | 7 percent by | percent | 7 percent |
| Type of leather | by weight) | weight | by weight) | by weight |
| Chromium-containing | 0.65 | 0.32 | 4.5 | 0.21 |
| leather | | | | |
| Chromium-free leather | 0.37 | 0.16 | 6 | 0.31 |

With chromium-free leather, volatilization amounts of formaldehyde and acetaldehyde also decreased when the back sizing agent containing ADH was coated on the back side of the leather, as was the case with chromium-containing leather.

### Example 5

How the volatilization amounts of aldehyde would change in each area was examined.

To confirm that the volatilization amounts of aldehyde would not change in different areas of cowhide, leather samples were taken from three locations of head, belly and buttocks and volatilization amounts of aldehyde were measured on each sample.
(1) Leather used
   Chromium-containing leather prepared in the same manner as in Example 1 was used.
(2) Coating of back sizing agent and formation of coating film
   For the back sizing agent, a mixture of a base back sizing agent (water-based emulsion of polyacrylic resin whose solid content of polyacrylic resin is 17%) and 7 percent by weight of ADH was used. A roll coater was used to coat the back sizing agent by 0.5 g/DS, after which the leather was dried at 80° C. for 60 minutes and then a base coat, color coat and topcoat were applied on the leather surface.
(3) Results
   Volatilization amounts of aldehyde were measured immediately after the finishing step and also after leaving the leather for 1 month at room temperature. The results are shown in Table 6.

TABLE 6

| | Volatilization amount of aldehyde (μg/DS) | | | |
|---|---|---|---|---|
| | Formaldehyde | | Acetaldehyde | |
| | Immediately | | Immediately | 1 month |
| Area of leather | after finishing | 1 month later | after finishing | later |
| Head | ND | ND | 0.11 | 0.12 |
| Belly | ND | ND | 0.11 | 0.08 |
| Buttocks | ND | ND | 0.14 | 0.15 |

There were no differences among the areas and volatilization amounts of aldehyde remained roughly the same after 1 month.

### Example 6

The results on perforated leather are shown below.

Sometimes ventilation holes are punched in leather. Such leather having ventilation holes is called “perforated leather.” Perforated leather was tested as follows because of the possibility of aldehyde volatilization amounts increasing with this type of leather due to volatilization occurring through the side faces of holes.
(1) Leather used
   Half-cut chromium-containing leather prepared in the same manner as in Example 1.
(2) Coating of back sizing agent, perforation and formation of coating film
   For the base back sizing agent, a water-based emulsion of polyacrylic resin (solid content of polyacrylic resin: 17%) was used, where ADH was added to the base back sizing agent so that its content became 7 percent by weight.
   (i) Normal leather (not perforated)
      A roll coater was used to coat the ADH-containing back sizing agent on the back side of the half-cut chromium-containing leather by 0.5 g/DS, after which a base coat, color coat and topcoat were applied and then the leather was heated at 60 ▪70° C. for 60 minutes.
   (ii) Perforated leather
      A roll coater was used to coat the ADH-free base back sizing agent on the back side of the half-cut chromium-containing leather by 0.5 g/DS, after which a base coat, color coat and topcoat were applied and then the leather was heated at 60 to 70° C. for 60 minutes.
      Next, a punching machine was used to make around 800 circular holes (of approx. 1 mm in diameter) per 1 DS, after which a roll coater was used to coat the ADH-containing back sizing agent on the back side of the leather by 0.5 g/DS and then the leather was dried at room temperature.
(3) Results
   The measured amounts of aldehyde volatilization are shown in Table 7.

TABLE 7

| | | Volatilization amount of aldehyde | |
|---|---|---|---|
| | | (μg/DS) | |
| Perforation | Area of leather | Formaldehyde | Acetaldehyde |
| Not perforated | Head | ND | 0.11 |
| | Belly | ND | 0.11 |
| | Buttocks | ND | 0.11 |
| Perforated | Head | ND | 0.06 |
| | Belly | ND | 0.09 |
| | Buttocks | ND | 0.07 |

Formaldehyde was not detected on either the normal leather or perforated leather. The volatilization amount of acetaldehyde was virtually the same between the normal leather and perforated leather, and the amounts of volatilization were also favorably small.

When the normal leather and perforated leather were stored at room temperature for 1 month after their manufacture and volatilization amounts of formaldehyde and acetaldehyde were measured again, the volatilization amounts were little different on both leathers and remained at favorably low levels around 0.1 μm/DS.

The above results confirm that a back sizing agent conforming to the present invention is also effective on perforated leather.

### INDUSTRIAL APPLICATION USE

The present invention discusses a natural leather used for car seats and automobile interior parts. The natural leather for preventing generation of formaldehyde and acetaldehyde, as proposed by the present invention, can also be utilized in place of natural leathers applied for general products, to prevent generation of formaldehyde and acetaldehyde.

1. A back sizing agent for natural leather characterized by being constituted by a hydrazide compound and water.

2. A back sizing agent for natural leather characterized by being constituted by a hydrazide compound, synthetic resin, and water.

3. A natural leather characterized by being obtained by treating a leather using a tanning agent, re-tanning agent, dyeing agent and greasing agent so that these agents are taken into all areas of the leather, and then coating the back side of the leather with a back sizing agent for natural leather that is constituted by a hydrazide compound and water according to claim 1.

4. A natural leather according to claim 3, characterized in that the treatment using the greasing agent is performed in the presence of an aqueous solution of sodium hydrogen sulfite.

5. A natural leather characterized by being obtained by treating a leather using a tanning agent, re-tanning agent, dyeing agent and greasing agent so that these agents are taken into all areas of the leather, and then coating the back side of the leather with a back sizing agent for natural leather that is constituted by a hydrazide compound, synthetic resin, and water according to claim 2.

6. A natural leather according to claim 5, characterized in that the treatment using the greasing agent is performed in the presence of an aqueous solution of sodium hydrogen sulfite.

7. A natural leather according to claim 5, characterized in that the synthetic resin is an acrylic resin.

8. A natural leather according to claim 3, characterized in that a resin coating film is formed on the surface of the natural leather.

9. An automobile interior part characterized by being covered by a natural leather according to claim 8.

10. A natural leather according to claim 5, characterized in that a resin coating film is formed on the surface of the natural leather.

11. An automobile interior part characterized by being covered by a natural leather according to claim 10.

12. An automobile seat characterized by being covered by a natural leather according to claim 8.

13. An automobile seat characterized by being covered by a natural leather according to claim 10.

14. A back sizing agent for natural leather characterized by being constituted by a hydrazide compound, sodium hydrogen sulfite, and water.

15. A back sizing agent for natural leather characterized by being constituted by a hydrazide compound, sodium hydrogen sulfite, synthetic resin, and water.

16. A natural leather characterized by being obtained by treating a leather using a tanning agent, re-tanning agent, dyeing agent and greasing agent so that these agents are taken into all areas of the leather, and then coating the back side of the leather with a back sizing agent for natural leather that is constituted by a hydrazide compound, sodium hydrogen sulfite, and water according to claim 14.

17. A natural leather characterized by being obtained by treating a leather using a tanning agent, re-tanning agent, dyeing agent and greasing agent so that these agents are taken into all areas of the leather, and then coating the back side of the leather with a back sizing agent for natural leather that is constituted by a hydrazide compound, sodium hydrogen sulfite, synthetic resin, and water according to claim 15.

18. A natural leather according to claim 17, characterized in that the synthetic resin is an acrylic resin.

19. A natural leather according to claim 16, characterized in that a resin coating film is formed on the surface of the natural leather.

20. A natural leather according to claim 17, characterized in that a resin coating film is formed on the surface of the natural leather.

21. An automobile interior part characterized by being covered by a natural leather according to claim 19.

22. An automobile interior part characterized by being covered by a natural leather according to claim 20.

23. An automobile seat characterized by being covered by a natural leather according to claim 19.

24. An automobile seat characterized by being covered by a natural leather according to claim 20.
